(19) United States
(12) Patent Application Publication
(10) Pub. No.: US 2025/0299447 A1
(43) Pub. Date: Sep. 25, 2025

(54) HIGH-QUALITY SKINNED OBJECT ANIMATIONS FOR DISPLACED MICRO MESHES

(71) Applicant: Advanced Mircro Devices, Inc., Santa Clara, CA (US)

(72) Inventor: Holger Gruen, Munich (DE)

(73) Assignee: Advanced Micro Devices, Inc., Santa Clara, CA (US)

(21) Appl. No.: 18/615,723

(22) Filed: Mar. 25, 2024

(51) Int. Cl. G06T 17/20; G06T 13/40; G06T 15/06

(52) U.S. Cl. CPC G06T 17/205; G06T 13/40; G06T 15/06; G06T 2210/21; G06T 2210/44

(57) ABSTRACT

A technique for performing graphics processing is provided. A displaced micro-mesh is created that includes a plurality of coarse base triangles that define a set of coarse vertices each of which has an associated directional value. The displaced micro-mesh also includes a set of displacement values. A fine triangular mesh defined by a plurality of fine vertices is formed by subdividing the coarse base triangles into fine triangles, interpolating directional values for the fine vertices based on directional values associated with the coarse vertices, and applying the displacement values to the interpolated directional values. Skinning is applied to the fine vertices.

### BACKGROUND

Displaced micro-meshes (p-meshes) are a polygonal representation for 3D models designed for efficient GPU rendering, particularly ray tracing. In some applications, displaced micro-meshes reduce mesh size and the size and construction time of acceleration structures. A y-mesh is a special type of displacement-mapped mesh that includes a coarse base triangular mesh and a set of scalar displacement values modeling high-frequency details. At rendering time, each base-mesh face is subdivided into y-triangles and the resulting y-vertices are displaced along interpolated normal directions.

In computer graphics and 3D computer animation, “skinning” refers to the process of deforming a 3D model's geometry based on the movement of underlying bones or joints. It is a technique used in character animation to create realistic movements and deformations of characters. Skinning allows animators to create lifelike movements by manipulating the underlying skeleton, causing the deforming mesh to follow.

In skinning, a 3D model of a character is associated with an underlying skeleton which includes bones or joints. These bones are positioned to match the structure of the character. Each vertex of the 3D model is associated with one or more bones. The influence of each bone on a vertex is determined by a set of weights. These weights define how much a particular bone affects a specific vertex. As the bones of the skeleton move or rotate, the vertices of the 3D model are deformed based on their weights. The skinning algorithm calculates the final position of each vertex by taking into account the transformations of the associated bones. Interpolation techniques are typically used to smooth the deformations.

### BRIEF DESCRIPTION OF THE DRAWINGS

A more detailed understanding may be had from the following description, given by way of example in conjunction with the accompanying drawings wherein:

FIG. 1 is a block diagram of an example computing device in which one or more features of the disclosure can be implemented;

FIG. 2 illustrates details of the device of FIG. 1 and an accelerated processing device, according to an example;

FIG. 3 is a block diagram showing additional details of the graphics processing pipeline illustrated in FIG. 2;

FIG. 4 is a conceptual diagram illustrating operation of an asset creation device and a rendering device, according to an example;

FIG. 5 is a conceptual diagram illustrating compression and decompression operations associated with a displaced micro-mesh, according to an example;

FIG. 6 depicts aspects of the decompression operation in further detail, according to an example.

FIG. 7 is a conceptual model depicting the application of skinning in connection with decompression of a base mesh, in accordance with an example.

FIG. 8 is a conceptual model depicting the application of skinning in connection with decompression of a base mesh, in accordance with a further example.

FIG. 9 depicts a base triangle in a base mesh and a hull formed from the base mesh, in accordance with an example.

FIG. 10 depicts the representation of a base triangle using a plurality of control points, and a convex surface defined by the control points.

FIG. 11 depicts a convex hull defined by control points, according to an example.

FIG. 12 is a flow diagram of a method for applying skinning in connection with decompression of a base mesh, according to an example.

### DETAILED DESCRIPTION

This disclosure describes techniques for graphics processing. A processor creates a displaced micro-mesh that includes a plurality of coarse base triangles that define a set of coarse vertices. This displaced micro-mesh is a “compressed” version of an original mesh. Each of the coarse vertices of the displaced-micro-mesh has an associated directional value (e.g., the normal vector at the vertex). The displaced micro-mesh also includes a set of displacement values that define the location of fine vertices when the compressed original mesh is decompressed to “restore” the original surface. More specifically, during decompression, the processor generates a fine triangular mesh defined by a plurality of fine vertices. To form the fine triangular mesh, the processor subdivides each of the coarse base triangles into a plurality of fine triangles that define the fine vertices, interpolates directional values for the fine vertices based on directional values associated with the coarse vertices, and applies displacement values from the set of displacement values to the interpolated directional values. The processor then applies skinning to the fine vertices.

In some examples, the displaced micro-mesh corresponds to animated graphics content, and skinning is performed in accordance with a skeleton having a plurality of bones each of which is associated with a transformational matrix. In these examples, the skinning comprises applying transformational matrices associated with the bones to the fine vertices. In some cases, multiple transformational matrices influence individual ones of the fine vertices.

In some examples, the displaced micro-mesh is created as a pre-processing step (e.g., by processing an “original mesh” such as an asset created for an application such as a video game), and generation of the fine triangular mesh and application of skinning to the fine vertices are implemented at runtime by a graphics processing pipeline (e.g., as a “decompression” step, which “restores” the original mesh).

In some examples, ray tracing is performed based on a hull defined by the coarse vertices. A ray intersection is identified by recursively decimating the hull into subdivisions and testing the subdivisions.

In other examples, ray tracing is performed based on a convex hull defined by control points associated with the base triangle. The convex hull is generated from a set of control points corresponding to a degree 2 degree Bezier triangle. The degree 2 degree Bezier triangle has a surface represented by weights associated with the control points. A ray intersection is identified by recursively decimating the convex hull into subdivisions and testing the subdivisions.

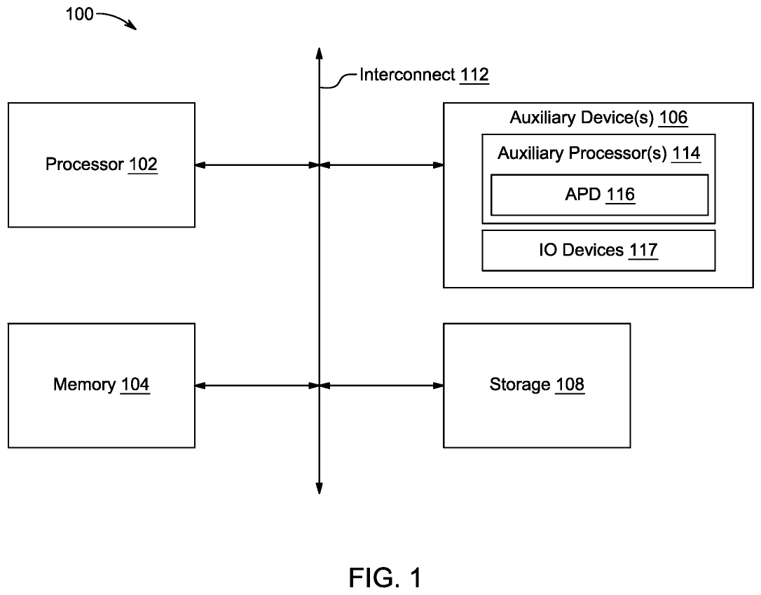

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

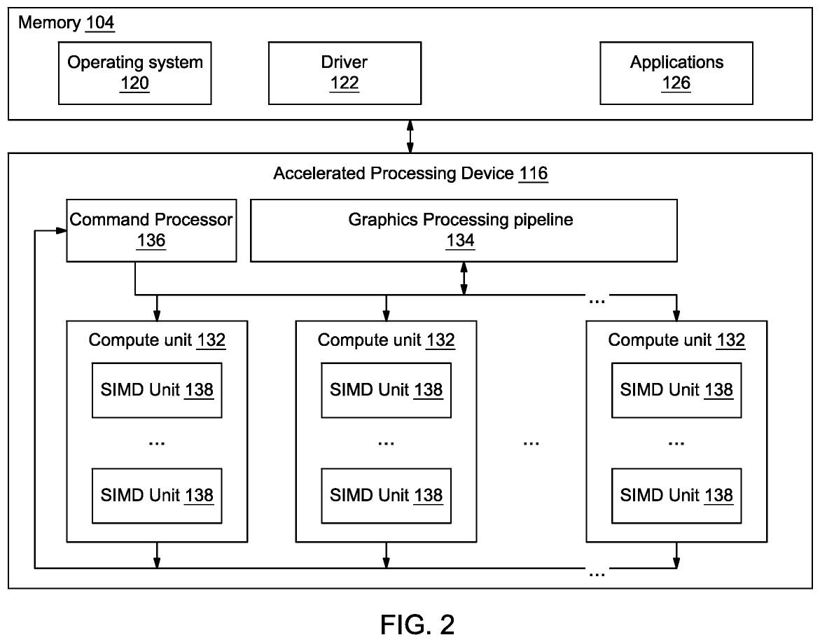

FIG. 2 illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to a display device based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. A command processor 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

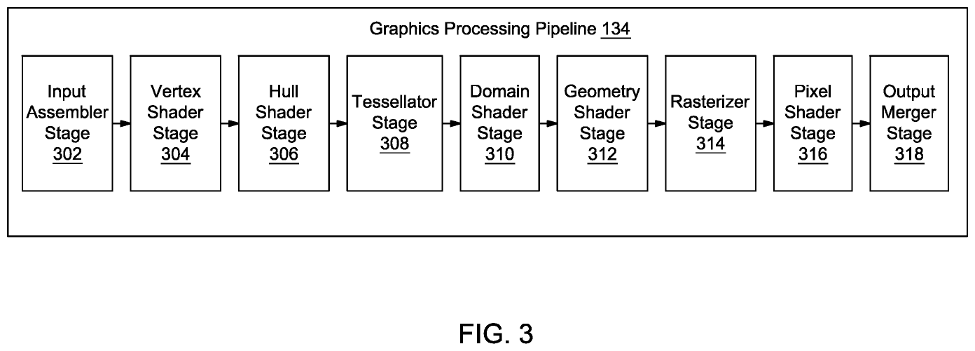

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

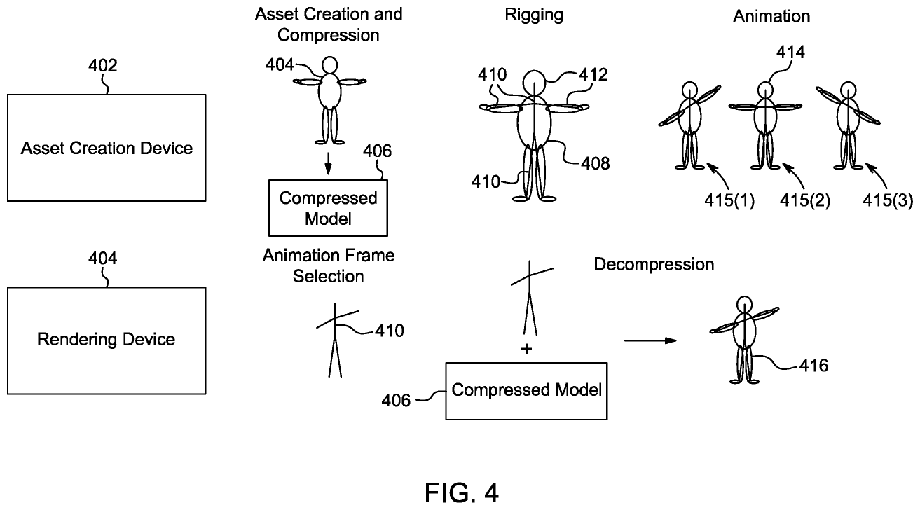

FIG. 4 is a conceptual diagram illustrating operation of an asset creation device and a rendering device, according to an example. In asset creation and compression, asset creation device 402 generates a compressed model 406 for an original model 404. In some examples, a human being or computer program generates the original model 404, such as by using 3D modeling software executing on the asset creation device 402. Then, the asset creation device 402 (e.g., via the same 3D modeling software and/or other software or hardware) compresses the original model 404 to generate the compressed model 406. The compressed model 406 includes a displaced micro-mesh. As used herein, a “displaced micro-mesh” is a displacement-mapped mesh that includes coarse base triangles with coarse vertices, a directional vector for each coarse vertex, and a set of scalar displacement values that model a level of detail that is higher than that represented by the coarse vertices.

In rigging and skinning, asset creation device 402 generates information used for animation of the model 404. To create such information, the asset creation device 402 (again, via, e.g., software such as 3D modeling software) generates and places bones 410 within the model 408, and generates animation frames 415 of an animation that describe the positions of the bones 410 within an animation. As the bones move between the positions defined by different frames 415, the bones apply modifications to the vertices of the mesh 412 (or “skin” in the context of animation). It should be understood that the deformation applied by the bones to the mesh 412 includes adjustments in addition to the simple translation of the vertices to match the movements of the bones 410. For example, it is possible in one animation frame 415 for vertices of a single triangle to be at a first set of positions relative to each other and in a different animation frame to be in a second, different set of positions relative to each other. The positional adjustments imposed by the bones are intended to impart the ability to adjust the mesh shape in an aesthetically pleasing and/or realistic way. The rigging and animation operations provide an animation of a 3D model that defines both a range of motion for the model as well as the manner in which the mesh 412 moves at each point in that range of motion.

In greater detail, each bone 410 influences one or more vertices of the mesh 412, and multiple bones can influence a particular vertex. This influence is based on weights assigned for each vertex-bone combination, indicating how much each bone affects a particular vertex. As the skeleton moves or rotates (relative to the rigging pose) during animation 414, each bone undergoes transformations, including, e.g., translation, rotation, and scaling. During skinning (performed by rendering device 404, discussed below), the position of each vertex is transformed based on the movements of the associated bones. More specifically, the rendering device 404 applies an animation matrix to each vertex that is affected by at least one bone 410. The animation matrix for a given vertex is equal to the sum of the product of contributions from each bone. The contribution for a bone is equal to the product of the weight of the vertex-bone combination, a vector describing the position of the vertex, and a matrix describing the transformation matrix of the bone. The transformation matrix of a bone is based on the position, rotation, and scaling of the bone. To transform any particular vertex for skinning, the rendering device 404 applies the animation matrix for the bone-vertex combination for each bone that affects that vertex.

Rendering device 404 uses compressed model 406 and the bones 410 as inputs, and applies a decompression model and skinning in order to render output model 416, which has had skinning applied. It should be understood that the output model 416 represents a single instant in time of an animation (e.g., of animation 414). Animation frame selection selects the particular animation frame 410, where an animation frame is based on the position of the bones 410. This selection is based on the current state of the character represented by the bones 410. In an example, an entity (such as a video game character) for which animation is occurring is at a particular point in the animation, such as 0.5 seconds into a 2 second animation. The rendering device 404 sets the bone positions based on this point in the animation, and then calculates the vertex positions of the mesh 412 based on the bone positions. In some examples, the operations performed by asset creation device 402 are implemented as a preprocessing operation and operations performed by rendering device 404 are implemented using graphics pipeline 134.

In various examples, the asset creation device 402 and the rendering device 404 are computing devices such as the device 100 of FIG. 1. In general, the asset creation device 402 and the rendering device 404 include components such as a memory, processor, bus, cache, and other components necessary for a computing device. In various examples, the processor, which is a programmable processor, fixed function processor, or any other technically feasible type of processor, performs the operations described herein as being performed by the asset creation device 402 or the rendering device 404. In various examples, the asset creation device 402 and rendering device 404 are the same or different devices.

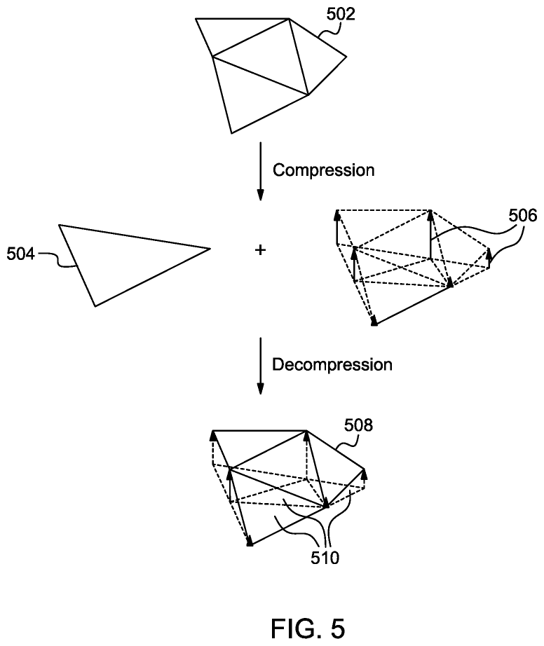

FIG. 5 is a conceptual diagram illustrating compression and decompression operations associated with a displaced micro-mesh, according to an example. In a compression operation, high-resolution input mesh 502 is compressed into a base mesh that includes a plurality of coarse base triangles 504. As part of the base mesh, positions and direction vectors are defined at each of the mesh vertices. The compression operation also results in a set of scalar displacement values 506 for each coarse triangle. The scalar displacement values represent a level of detail that is higher than that of the vertices of the base mesh. In one embodiment, the compression of high-resolution input mesh into the base mesh and scalar displacement values is performed by asset creation device 402.

Referring still to FIG. 5, decompression of the base mesh (into decompressed mesh 508) is performed by dividing each coarse triangle 504 in the base mesh into a set of micro-triangles 510 (or fine triangles). Each micro-triangle 510 is defined by micro-vertices that are barycentrically interpolated from the vertices of the coarse triangle 504 from which the micro-triangle was subdivided. In addition, for each micro-vertex, the direction vectors of the vertices of the coarse triangle are barycentrically interpolated to form the direction vector of the micro-vertex. As part of decompression, the direction vector for each micro-vertex is scaled by one of the scalar displacement values and added to the interpolated position to produce a displaced micro-vertex. In one embodiment, the decompression is performed by rendering device 404.

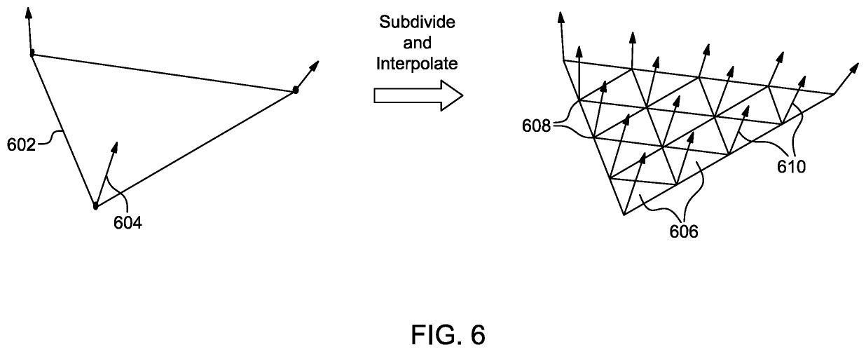

FIG. 6 depicts aspects of the decompression operation in further detail, according to an example. Triangle 602 corresponds to a coarse triangle in the base mesh discussed in connection with FIG. 5. The vertices associated with triangle 602 represent a low level of detail. As part of the base mesh, direction vectors 604 are defined at each of the vertices of triangle 602. The direction vectors point in a direction that is normal to the surface being modelled. During decompression of the base mesh, base triangle 602 is subdivided into a regular grid of micro-triangles 606 (or fine triangles). Each micro-triangle 606 is defined by micro-vertices 608 that are barycentrically interpolated from the positions (vertices) of the coarse triangle 602 from which the micro-triangle was subdivided. A micro-directional vector 610 at each micro-vertex is also barycentrically interpolated from the direction vectors 604 of the coarse triangle 602 from which the micro-triangle was subdivided.

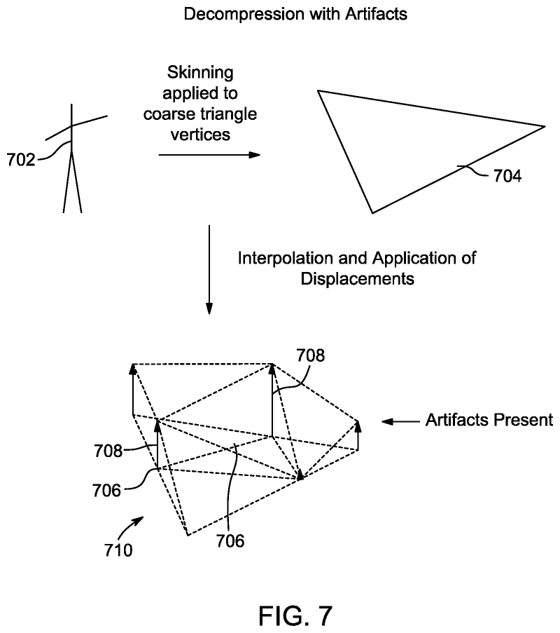

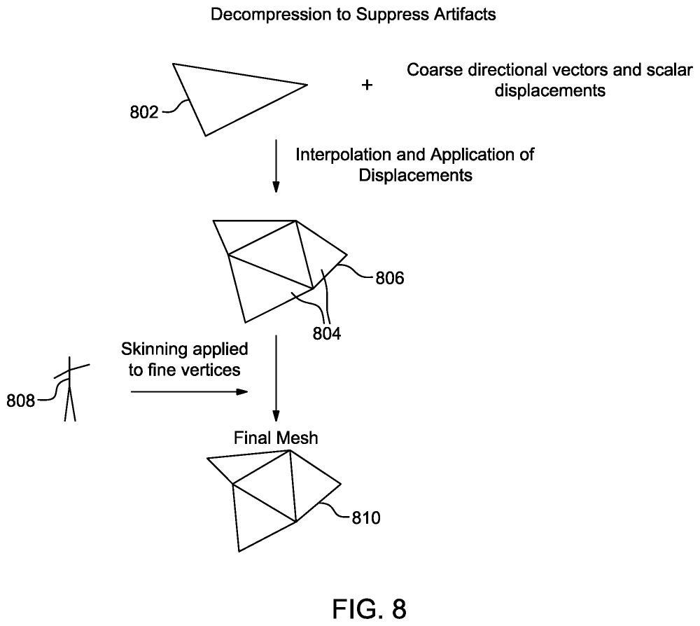

FIG. 7 is a conceptual model depicting the application of skinning in connection with decompression of a base mesh, in accordance with an example. In FIG. 7, skeleton 702 includes the bones 410 for a particular frame of animation. In particular, the skeleton 702 includes information indicating the transformation for each of the bones 410 as compared to the base “skinning” pose. In the example of FIG. 7, skinning is applied to the base triangles prior to interpolation of the micro-vertices (e.g., micro-vertices 608) and micro-direction vectors (e.g., micro-direction vectors 610) from the base triangle. More specifically, the transformational matrices of the skeleton 702 are used to transform the position and direction vectors associated with the base triangle into a transformed (or skinned) base triangle 704. In this process, the positions of the vertices and the direction vectors of the base triangle are transformed by applying a weighted sum of the animation matrices defined by the skeleton 702 to the base triangle. The system subsequently barycentrically interpolates micro-vertices 706 and micro-direction vectors 708 from the transformed base triangle 704, and applies the scalar displacement values associated with the displaced micro-mesh to each of the micro-vertices 706 to arrive at transformed vertices, illustrated as mesh 710. A disadvantage of the process depicted in FIG. 7 is that it often results in the presence of artifacts in the final mesh. This result is because the displacements 708 are defined for the rigging pose. If these same displacements are applied to a triangle that is transformed based on animation (e.g., skinning), then these displacements may not be “correct” for the configuration of the mesh that occurs after animation of the skeleton 702 (which results in a new mesh configuration). As a result, a different technique is described elsewhere herein, such as with respect to FIG. 8.

FIG. 8 is a conceptual model depicting the application of skinning in connection with decompression of a base mesh, in accordance with a further example. In contrast to the model of FIG. 7, in the model of FIG. 8 the subdividing of the base triangles and interpolation process depicted in FIG. 6 is applied before skinning. In FIG. 8, triangle 802 corresponds to a coarse triangle in the base mesh discussed in connection with FIG. 5. Direction vectors are defined at each of the vertices of triangle 802. The direction vectors point in a direction that is normal to the surface being modelled. The direction vectors along with scalar displacements are stored along with or as part of base triangle 802. The decompressed mesh 806 is formed by subdividing base triangle 802 into a regular grid of micro-triangles 804. As explained in connection with FIG. 6, each micro-triangle is defined by micro-vertices that are barycentrically interpolated from the positions (vertices) of base triangle 802. A micro-directional vector at each micro-vertex is also barycentrically interpolated from the direction vectors of base triangle 802.

Referring still to FIG. 8, skinning is applied to the decompressed mesh 806. More specifically, transformational matrices of the skeleton 808 are used to transform the displaced micro-vertices and micro-direction vectors associated with the decompressed mesh 806 into a final mesh 810. In this process, the displaced micro-vertices and micro-direction vectors of the micro-triangles in decompressed mesh 806 are transformed by applying an interpolated skinning matrix that gets interpolated for each of the micro-vertices. In some examples, the combined weighted sum of the animation matrices for each bone of the skeleton 808 is only defined for the coarse vertices from FIG. 6. As a result, a new matrix needs to be barycentrically interpolated for each micro-vertex. This matrix is a elements-wise barycentric interpolation of the weighted sum of matrices at each coarse vertex. The resulting interpolated skinning matrices are then applied to the displaced micro-vertices and micro-direction vectors of the micro-triangles triangle.

In one example of the process of FIG. 8, a skinning matrix is computed at each coarse vertex. This matrix is the weighted sum of all current bone-matrices that affect such coarse vertex. In the case of a coarse triangle, there are three such bone-matrices, one for each coarse vertex. At each micro-vertex interpolated from three coarse vertices, a barycentric interpolation of the three matrices is performed to calculate a skinning matrix for the micro-vertex. These interpolated matrices are used to skin the rigging-pose detailed vertices. In one example, each micro-vertex (ignoring displacements) is determined in accordance with equation (1) as follows:

$$Micro\_Vertex = ( V0\_coarse * b 0 + V1\_coarse * b 1 + V2\_coarse * b 1 ) * M \qquad ( 1 )$$

As explained above in connection with FIG. 5, each micro-triangle 510 is defined by micro-vertices that are barycentrically interpolated from the vertices of the coarse triangle 504 from which the micro-triangle was subdivided. In addition, for each micro-vertex, the direction vectors of the vertices of the coarse triangle are barycentrically interpolated to form the direction vector of the micro-vertex. In equation (1), b0, b1 and b2 correspond to the three barycentric coordinates of a micro-vertex of one of the micro-triangles, and V0_coarse, V1_coarse and V2_coarse are the vertices of the coarse triangle.

In equation (1), the bone-matrices that affect V0_coarse, V1_coarse and V2_coarse are being animated. For example, V0_coarse has a number of bone matrices (m0 . . . mN) affecting it, each matrix having a weight. In one example, these matrices (m0 . . . mN) are summed in accordance with equation (2) as follows:

$$mskinning 0 \_coarse = weight 0 * m 0 + weight 1 ⋆ m 2 + … + weight N ⋆ mN \qquad ( 2 )$$

In this example, the methodology of equation (2) is similarly applied to V1_coarse and V2_coarse to determine mskinning1_coarse (for V1_coarse) and mskinning2_coarse (for V2_coarse). In equation (1), M is the barycentric interpolation of these three skinning matrices and is used to transform the micro-vertex. In one example, M is determined in accordance with equation (3) as follows:

$$M = ( mskinning 0 \_coarse * b 0 + mskinning1 \_coarse ⋆ b 1 + mskinning2\_coarse * b 1 ) ) \qquad ( 3 )$$

As noted above, equation (1) ignores the need to apply displacements along the interpolated coarse normal to each micro-vertex. In one example, the interpolated normal is applied in accordance with equation (4) as follows:

$$Micro\_vertex = ( ( V0\_coarse * b 0 + V1\_coarse ⋆ b 1 + V2\_coarse * b 1 ) * M + displacement * ( N0\_coarse * b 0 + N1\_coarse ⋆ b 1 + N2\_coarse * b 1 ) ) ⋆ M \qquad ( 4 )$$

where M is determined in accordance with equation (3) above. In equation (4), the displaced micro-vertex in the rigging being skinned or transformed by M corresponds to:

$$( V0\_coarse * b 0 + V1\_coarse * b 1 + V2\_coarse * b 1 ) + displacement * ( N0\_coarse * b 0 + N1\_coarse * b 1 + N2\_coarse * b 1 ) )$$

In some examples, the formula of equation (1) is reduced to a curved surface patch written as a degree 2 bezier triangle. A Bezier triangles of degree two is evaluated by equation (5) where cp_xyz are control points of the Bezier-triangle:

$$P ( b 0 , b 1 , b 2 ) or ( with b 0 = u , b 1 = v , b 2 = w ) ; P ( u , v , w ) = u \hat{} 2 * cp\_ 200 + v \hat{} 2 * cp\_ 020 + w \hat{} 2 * cp\_ 002 + 2 * u * v * cp\_ 110 + 2 * v * w * cp\_ 011 + 2 * w * u * cp\_ 101 \qquad ( 5 )$$

Expanding (u*v0+v*v1+w*v2)*(u*m0+v*m1+w*m2) (where v0/1/2=V0/1/2_coarse and m0/1/2 is mskinning0/1/2_coarse as set forth above), results in the following:

$$m 2 v 2 {w}^{2} + ( ( m 1 v 2 + m 2 v 1 ) v + ( m 0 v 2 + m 2 v 0 ) u ) w + m 1 v 1 {v}^{2} + ( m 0 v 1 + m 1 v 0 ) uv + m 0 v 0 {u}^{2}$$

Since u\hat{ }2, v\hat{ }2, w\hat{ }2, u*v, v*w and w*u are all in the expansion above, cp_200=v0*m0, cp_020=v1*m1, cp_002=v2*m2, cp_110=(v1 m0+v0 m1)/2, cp_011=(v2 m1+v1 m2)/2 and cp_101=(v2 m0+v0 m2)/2, which corresponds to a curved surface patch written as a degree 2 bezier triangle.

The process of FIG. 8 is different from the process of FIG. 7, in which the animation matrices are first applied to the vertices of the coarse triangle and then micro-triangles and micro-vertices are generated from that base triangle, using the displacements stored for the compressed mesh. In the technique of FIG. 8, the animation matrices are applied to the expanded micro-triangles and micro-vertices. An advantage of the process depicted in FIG. 8 is that it suppresses artifacts in the final mesh 810 that would have otherwise resulted if the process of FIG. 7 had been used. More specifically, the displacements stored are for the base (“rigging”) pose. Applying those displacements to the micro-vertices of the decompressed micro-triangles in the base pose means that such displacements are applied for the model in the configuration that the displacements were generated for. Applying the animation matrices to such micro-vertices thus provides results having fewer artifacts.

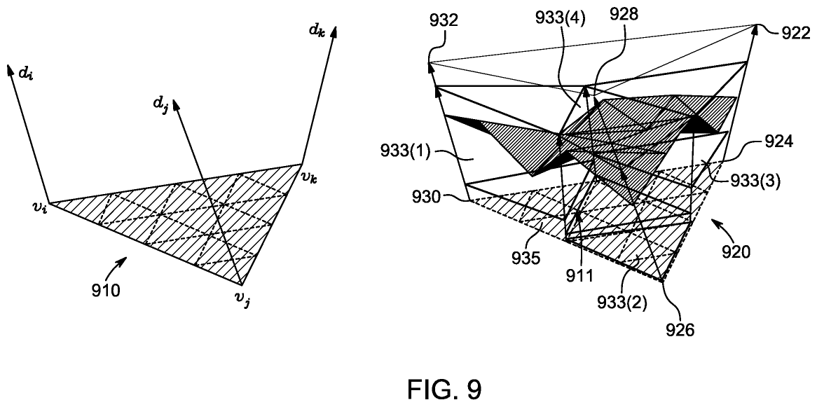

FIG. 9 depicts a base triangle 910 in the base mesh and a hull 920 formed from the base mesh 920, in accordance with an example. The hull 920 describes a bounding volume that is used for ray tracing. More specifically, during ray tracing, a processor (sometimes referred to as a “ray tracing processor,” which can include, for example, a CPU, GPU, or other programmable or fixed function processor having appropriate circuitry) performs ray tracing operations using a bounding volume hierarchy. The bounding volume hierarchy is a tree that includes leaf nodes and non-leaf nodes. The non-leaf nodes include bounding volumes and pointers to children of such non-leaf nodes. The leaf nodes represent underlying geometry. The bounding volume of any given non-leaf node bounds all underlying geometry of leaf nodes that are descendants of that non-leaf node. In some examples, a portion of a displaced micro-mesh (such as the micro-mesh portion 911) is represented by a leaf node in a bounding volume hierarchy. A ray tracing operation involves casting a ray into a scene represented by a bounding volume hierarchy. When the ray arrives at a non-leaf node, the ray tracing processor tests the ray for intersection with the bounding volume of the non-leaf node. In the event that there is no intersection, the ray tracing processor does not consider the children of that non-leaf node and in the event that there is an intersection, the ray tracing processor does consider the children of that leaf node, performing further tests for such children.

In the examples described herein, a displaced micro-mesh portion 911 has an associated hull 920 that is used for the intersection test once the ray tracing operation arrives at the leaf node of the micro-mesh portion 911. To avoid decompressing the entire displaced micro-mesh portion 911, the ray tracing processor performs testing against this hull 920, along with recursive decimation to form smaller hulls and testing of such smaller hulls for intersection of the ray until a small enough hull is arrived at. At this point, the ray tracing processor tests the micro-triangle contained with the “small enough” decimated hull for intersection with the ray.

In FIG. 9, base triangle 910 is defined by vertices (vᵢ, vⱼ and vₖ). Direction vectors (dᵢ, dᵢ, and dₖ) and the scalar displacements (not shown) are also stored as part of, or along with, base triangle 910. In the example of FIG. 9, the minimum and maximum values in the set of scalar displacements are applied at the vertices (vᵢ, vⱼ and vₖ) along the directions of the direction vectors (dᵢ, dⱼ, and dₖ) to define hull 920. For example, the boundary point 922 of hull 920 is determined by applying the maximum scalar displacement in the set to vertex vₖ in the direction of dₖ, and the boundary point 924 of hull 920 is determined by applying the minimum scalar displacement in the set to vertex vₖ in the direction of dₖ. By applying the same calculation method to the other two vertices, the system defines the remaining four boundary points 926, 928, 930, 932 of hull 920.

In the example of FIG. 9, once the ray tracing processor arrives at the leaf node corresponding to the hull 920, the ray tracing processor tests the ray for intersection with the hull 920. In the event that the ray tracing processor determines that the ray intersects the hull 920, the ray tracing processor “decimates” the hull, forming new hulls 933 using the base triangle 910. Each new “decimated” hull 933 is smaller than the original hull 920 for which the intersection occurred. In some examples, the original hull 920 is associated with a plurality of micro-triangles 935. Each decimated hull 933 is associated with a subset of the micro-triangles 935 of the original hull 320. Further, the “top” and “bottom” of each such decimated hull 933 is based on the minimum and maximum displacements of the micro-triangles 935 of that decimated hull 933 (and not those of the entire original hull 920). Thus, the top and bottom of each such decimated hull 933 is not necessarily the same as that of the original hull 920. In the example shown, four decimated hulls 933 are formed, each corresponding to four micro-triangles of the original hull 920. The ray tracing processor tests the ray for intersection with the decimated hulls 933, repeats the above steps for any decimated hull 933 that the ray intersects, and does not perform the above steps for any decimated hull 933 that the ray does not intersect (thus not further processing or considering such decimated hulls 933). The ray tracing processor stops decimating the hulls when a termination condition occurs, such as when the hull intersected corresponds to a threshold number of micro-triangles 935 (e.g., 1). For example, when a hull 933 corresponds to one micro-triangle, the ray tracing processor cannot further subdivide the hull, generates the triangle for that hull (e.g., based on the techniques described elsewhere herein such as with respect to FIGS. 5, 6, and 8), and tests the ray for intersection with that triangle. Based on the result of that intersection test, the ray tracing processor performs any technically feasible additional steps such as executing an appropriate shader (e.g., hit shader, miss shader, or other shader). The above allows the ray tracing processor to test triangles for intersection while eliminating other triangles from consideration by testing against hulls, thereby reducing the total number of triangle intersection tests performed.

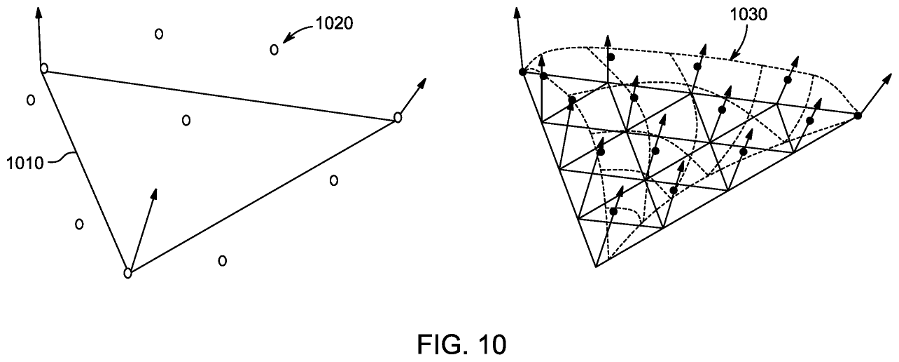

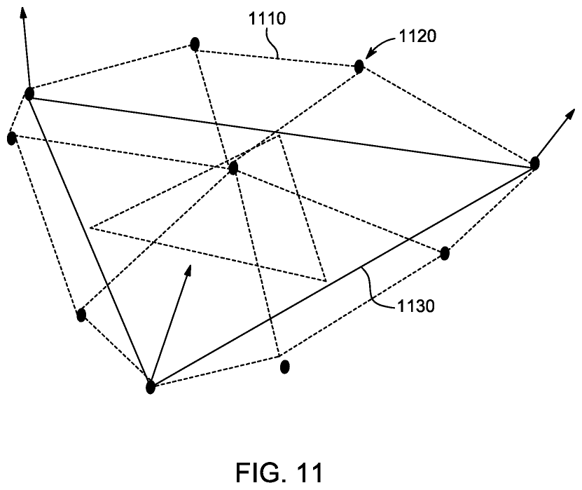

FIG. 10 depicts the representation of a base triangle using a plurality of control points, and a convex hull 1030 defined by the control points. This figure in conjunction with FIG. 11 illustrates an alternative technique for performing ray tracing as compared with that shown in FIG. 9. In the example of FIG. 10, the vertices and direction vectors associated with base triangle 1010 are representable as a degree 2 Bezier triangle having a surface expressible as weighted positions of control points 1020. A degree 2 Bezier triangle refers to a triangular surface in computer graphics defined using Bezier curves of degree 2. Bezier triangles are a way to represent curved surfaces in three-dimensional space. The degree of the Bezier curve indicates the polynomial degree used in the parametric equations that define the curve. In the example of FIG. 10, a Bezier triangle of degree 2 is defined by control points 1020 which determine the shape of the curved surface 1030 within the triangle. In one example of the degree 2 Bezier triangle, the parametric equations for the surface are expressed in terms of barycentric coordinates, where weights are used to influence each control point 1020 based on the barycentric coordinates. In the example discussed above, a new ‘skinning matrix’ is interpolated for each micro-vertex. Applying these interpolated skinning matrices to the micro-vertices (which got in turn computed by interpolating from three coarse vertices) creates a curved surface patch P which can be mathematically written as 2 degree 2 Bezier triangle. The same can be done for the interpolated micro-directions which forms a second degree 2 Bezier triangle N. In some examples, the final skinned high-res surface is written as the sum of P and a scaled version of N. Here the scaling is defined by the scalar displacement field computed during decompression.

FIG. 11 depicts a convex hull 1110 defined by control points 1120 associated with a base triangle 1130. In this example, the vertices and direction vectors associated with base triangle 1130 are used to compute the control points 1120 of P and N. The hull 1110 is defined by weighted positions of control points 1120. In one example, a ray tracing operation applies a ray intersection test to hull 1110 and, if there is an intersection, the ray tracing operation recursively decimates hull 1110 into subdivisions and tests the subdivisions in a similar manner as with respect to FIG. 9. More specifically, the ray tracing processor tests the ray for intersection with a convex hull that encloses the control points 1120 of the coarse triangle. If there is an intersection, then the ray tracing processor generates a Bezier surface hull-based convex hull for sub-sections of the coarse triangle (e.g., which covers a subset of the micro-triangles of the coarse triangle) and tests the ray for intersection with each such Bezier surface. The ray tracing subdivides the hull for each intersected hull and repeats these steps until a termination condition (such as arriving at a hull corresponding to one micro-triangle) occurs.

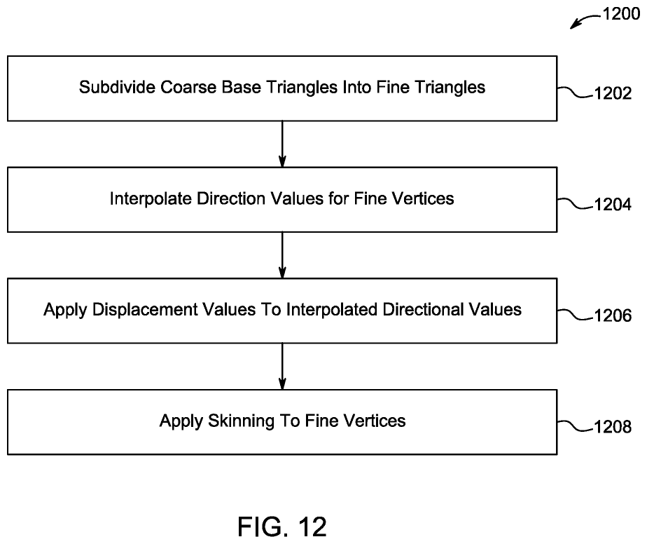

FIG. 12 is a flow diagram of a method 1200 for applying skinning in connection with decompression of a base mesh, according to an example. Method 1200 is applied to a displaced micro-mesh that includes a plurality of coarse base triangles that define a set of coarse vertices each of which has an associated directional value. The displaced micro-mesh further includes a set of displacement values. In some examples, a human being or computer program generates the original model, such as by using 3D and compresses the original model to generate the displaced micro-mesh. In some example, the base mesh represents a single instant in time of an animation. As explained below, in steps 1202-1206 of the method, a rendering device generates a fine triangular mesh defined by a plurality of fine vertices; and in step 1208, the rendering device applies skinning to the fine vertices.

In step 1202, the rendering device subdivides each of the coarse base triangles into a plurality of fine triangles that define the fine vertices. In one example, step 1202 includes dividing each coarse triangle in the base mesh into a set of micro-triangles or fine triangles. Each micro-triangle is defined by micro-vertices.

In step 1204, the rendering device interpolates directional values for the fine vertices based on directional values associated with the coarse vertices. In one example, the micro-vertices are barycentrically interpolated from the vertices of the coarse triangle from which the micro-triangle was subdivided. In some such examples, for each micro-vertex, the rendering device (as part of step 1204) barycentrically interpolates the direction vectors of the vertices of the coarse triangle are to form the direction vector of the micro-vertex.

In step 1206, the rendering device applies displacement values from the set of displacement values to the interpolated directional values. In one example of step 1206, the direction vector for each micro-vertex is scaled by one of the scalar displacement values and added to the interpolated position to produce a displaced micro-vertex.

In step 1208, the rendering device applies skinning to the fine vertices. In one example, the rendering device uses transformational matrices of a skeleton to transform the displaced micro-vertices and micro-direction vectors. In one example, the rendering device transforms the displaced micro-vertices and micro-direction vectors of the micro-triangles by applying a weighted sum of the animation matrices for each bone of the skeleton to the displaced micro-vertices and micro-direction vectors of the micro-triangles triangle.

In some examples, a processor performs ray tracing based on a hull defined by the coarse vertices. A ray intersection unit identifies an intersection by recursively decimating the hull into subdivisions and testing the subdivisions. In some examples, a processor performs ray tracing based on a convex hull defined by control points associated with the base triangle. The convex hull is generated from a set of control points corresponding to a degree 2 degree Bezier triangle. The degree 2 degree Bezier triangle has a surface represented by weights associated with the control points. A ray intersection unit identifies an intersection by recursively decimating the convex hull into subdivisions and testing the subdivisions.

It should be understood that many variations are possible based on the disclosure herein. Although features and elements are described above in particular combinations, each feature or element can be used alone without the other features and elements or in various combinations with or without other features and elements.

The methods provided can be implemented in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be mask works that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
based on a displaced micro-mesh that includes a plurality of coarse base triangles that define a set of coarse vertices each of which has an associated directional value, the displaced micro-mesh further comprising a set of displacement values, generating a fine triangular mesh defined by a plurality of fine vertices, wherein the generating comprises:
subdividing each of the coarse base triangles into a plurality of fine triangles that define the fine vertices;
interpolating directional values for the fine vertices based on directional values associated with the coarse vertices; and
applying displacement values from the set of displacement values to the interpolated directional values; and
applying skinning to the fine vertices.

2. The method of claim 1, wherein the displaced micro-mesh corresponds to animated graphics content.

3. The method of claim 1, further comprising interpolating a skinning matrix at each fine vertex from a sum of weighted skinning matrices at each coarse vertex, and applying the skinning to the fine vertices using the interpolated skinning matrix.

4. The method of claim 1, wherein the displaced micro-mesh is created as a pre-processing step, and the generating of the fine triangular mesh and the applying of the skinning to the fine vertices are implemented at runtime by a graphics processing pipeline.

5. The method of claim 1, further comprising performing ray tracing based on a convex hull defined by Bezier control points derived from the coarse vertices and a current sum of weighted skinning matrices at each coarse vertex.

6. The method of claim 5, wherein the ray tracing further comprises identifying a ray intersection by recursively decimating the convex hull into subdivisions and testing the subdivisions.

7. The method of claim 6, wherein the Bezier control points correspond to a degree 2 degree Bezier triangle.

8. The method of claim 1, wherein the skinning is performed in accordance with a skeleton having a plurality of bones each of which is associated with a transformational matrix, and applying the skinning comprises applying transformational matrices associated with the bones to the fine vertices.

9. The method of claim 1, wherein a plurality of transformational matrices influence at least one of the fine vertices.

10. A system comprising:
a memory that stores a displaced micro-mesh; and
a processor coupled to the memory and configured to:
based on a displaced micro-mesh that includes a plurality of coarse base triangles that define a set of coarse vertices each of which has an associated directional value, the displaced micro-mesh further comprising a set of displacement values, generate a fine triangular mesh having a plurality of fine vertices by:
subdividing each of the coarse base triangles into a plurality of fine triangles that define the fine vertices;
interpolating directional values for the fine vertices based on directional values associated with the coarse vertices; and
applying displacement values from the set of displacement values to the interpolated directional values; and
apply skinning to the fine vertices.

11. The system of claim 10, wherein the displaced micro-mesh corresponds to animated graphics content.

12. The system of claim 10, wherein the processor is configured to interpolate a skinning matrix at each fine vertex from a sum of weighted skinning matrices at each coarse vertex, and the processor is further configured to apply the skinning to the fine vertices using the interpolated skinning matrix.

13. The system of claim 10, wherein the processor is configured to create the displaced micro-mesh and store the displaced micro-mesh in the memory in an asset creation operation, and the processor is configured to generate the fine triangular mesh and apply skinning to the fine vertices at runtime using a graphics processing pipeline.

14. The system of claim 10, wherein the processor is further configured to performing ray tracing at runtime based on a convex hull defined by Bezier control points derived from the coarse vertices and a current sum of weighted skinning matrices at each coarse vertex.

15. The system of claim 14, wherein the processor is configured to perform the ray tracing by recursively decimating the convex hull into subdivisions and testing the subdivisions for ray intersections.

16. The system of claim 15, wherein the Bezier control points correspond to a degree 2 degree Bezier triangle.

17. The system of claim 10, wherein the processor is configured to perform the skinning in accordance with a skeleton having a plurality of bones each of which is associated with a transformational matrix, and apply transformational matrices associated with the bones to the fine vertices.

18. The system of claim 17, wherein a plurality of transformational matrices influence at least one of the fine vertices.

19. A non-transitory computer-readable medium storing instructions that, when executed by a processor, cause the processor to perform operations comprising:
based on a displaced micro-mesh that includes a plurality of coarse base triangles that define a set of coarse vertices each of which has an associated directional value, the displaced micro-mesh further comprising a set of displacement values, generate a fine triangular mesh defined by a plurality of fine vertices by subdividing each of the coarse base triangles into a plurality of fine triangles that define the fine vertices, interpolating directional values for the fine vertices based on directional values associated with the coarse vertices, and applying displacement values from the set of displacement values to the interpolated directional values; and
apply skinning to the fine vertices.

20. The non-transitory computer-readable medium of claim 19, wherein the displaced micro-mesh corresponds to animated graphics content.
